(19) United States
(12) Patent Application Publication
(10) Pub. No.: US 2017/0051908 A1
(43) Pub. Date: Feb. 23, 2017

(54) HEAT DISSIPATION STRUCTURE FOR LED AND LED LIGHTING LAMP INCLUDING THE SAME

(71) Applicants: Sun Hwa HWANG, Daejeon (KR); LEDIX CO., LTD., Daejeon (KR)

(72) Inventors: Sun Hwa HWANG, Daejeon (KR); Dong Yol YANG, Daejeon (KR); Han Jin KO, Daejeon (KR); Ho Seong CHAE, Daejeon (KR)

(21) Appl. No.: 14/952,991

(22) Filed: Nov. 26, 2015

(30) Foreign Application Priority Data
Aug. 18, 2015 (KR) 10-2015-0116012

(51) Int. Cl. F21V 29/77; F21V 29/56

(52) U.S. Cl. CPC F21V 29/773; F21V 29/56; F21Y 2115/10

(57) ABSTRACT

A heat dissipation structure for an LED and an LED lighting lamp including the same are disclosed. The LED lighting lamp is constructed such that the heat generated by the LED module attached to the upper portion of the cylindrical body is rapidly dissipated to the outside in such a manner that the heat is transmitted to the radiating fins through the operational fluid, which flows to the upper portion through the fluid through space having flow paths therein, thereby remarkably improving heat dissipation efficiency.

### BACKGROUND OF THE INVENTION

Field of the Invention

The present invention relates to a heat dissipation structure for an LED and an LED lighting lamp including the same, and more particularly to a heat dissipation structure for an LED and an LED lighting lamp including the same, in which the heat generated by an LED module attached to the upper port ion of a cylindrical body is rapidly dissipated to the outside in such a manner that the heat is transmitted to radiating fins through an operational fluid, which flows to the upper portion through a fluid through space having flow paths therein, thereby remarkably improving the heat dissipation efficiency.

Description of the Related Art

A light-emitting diode (LED) is a kind of semiconductor that employs the phenomenon of luminescence, which is caused by the conversion of electric energy into light and heat energy. Recently, LEDs have come to be extensively used in lighting boards, street lights, floodlights, fishing lights, harbor lights and the like, and offer an advantage of realizing light of various colors.

A lighting fixture employing such LEDs is constructed such that a base board, on which the LEDs are mounted, is disposed in a housing and has a cover disposed thereunder, and such that a support member is coupled to a portion of the fixture connected to a support post. However, such lighting fixtures have a problem in that it is impossible to efficiently dissipate the heat generated by a high power LED and as well as ambient heat caused by radiation from the sun or other sources in the lighting fixture during the operation of the lighting fixture. When the temperature of the LED mounted in the lighting fixture increases, the forward voltage is decreased, thereby decreasing the luminescent efficiency and shortening the service life.

Specifically, although a general lighting fixture, such as a fluorescent lamp or an incandescent lamp, generates light together with heat, an LED generates light in a forward direction and generates heat in a rearward direction, that is, toward the inside of the LED module. If the heat cannot be dissipated to the outside, all of the heat remains inside the LED module, which causes breakage or deformation of parts such as an LED chip and a PCB, thereby shortening the service life of the LED product. In other words, the generation of heat is the most important cause of decreased lifespan of the LED. Dissipating the heat inside the LED product to the outside is merely the function of a cooling device such as a radiator plate and a heat sink.

Since the efficiency of the radiator plate is increased with the increase in the heat conductivity thereof, it is most preferable that the radiator plate be made of a copper plate. However, in many cases the radiator plate is usually made of an aluminum material, because the copper plate is very expensive. In addition, since the heat dissipation efficiency is increased with the increase in contact area, it is preferable that the radiator plate have as large a surface area as possible. For this reason, the radiator plate is configured to have an irregular shape.

For example, a conventional cooling device, which may be applied to small-sized portable and stationary electronic systems, includes a heat sink, a fan, a small radiating device with a circular cross-section having a diameter of 3 mm or more, and the like.

Since heat sinks can be manufactured to have any desired size or thickness, heat sinks have been extensively used as essential elements in cooling devices. However, when heat sinks are required to be very small, there is a problem in that the heat dissipation efficiency is decreased in proportion to the decrease in the heat transfer area.

As for the fan, there is a lower limit to the size of a fan that can be manufactured, and the reliability of operation thereof is somewhat deteriorated.

A small-sized heat dissipation device having a circular cross-section with a diameter of 3 mm or more may be properly pressed and bonded to a thin film structure. However, when the small-sized heat dissipation device having a circular cross-section is pressed so as to be suitable for electronic equipment having a small-sized or thin film structure, the heat transfer performance is greatly deteriorated.

### DOCUMENTS OF THE RELATED ART

### Patent Documents

(Patent Document 1)

Korean Patent Registration No. 10-1318141 (2013 Oct. 8)

(Patent Document 2)

Korean Patent Registration No. 10-1199592 (2012 Nov. 2)

### SUMMARY OF THE INVENTION

Therefore, the present invention has been made in view of the above problems, and it is an object of the present invention to provide a heat dissipation structure for an LED and an LED lighting lamp including the same, in which the heat generated by the LED module attached to the upper portion of the cylindrical body is rapidly dissipated to the outside in such a manner that the heat is transmitted to the radiating fins through an operational fluid, which flows to the upper portion through the fluid through space having flow paths therein, thereby remarkably improving heat dissipation efficiency.

In accordance with the present invention, the above and other objects can be accomplished by the provision of a heat dissipation structure for an LED including a cylindrical body, which includes inner and outer walls each having a hollow cylindrical shape, and which is closed at an upper end thereof by a circular plate, radiating fins integrally formed on the outer surface of the cylindrical body, a fluid through space, which is defined between the inner and outer walls of the cylindrical body and which is filled operational fluid, at least one partition disposed in the fluid through space to divide the fluid through space into a plurality of space segments, a plurality of fine capillary pipes, which are formed on the inner surface of the fluid through space and which constitute flow paths that use capillary force, and a fluid-flowing cover, which is detachably coupled to the upper portion of the cylindrical body so as to communicate with the fluid through space and uniformly distribute the operational fluid throughout the upper portion of the cylindrical body.

The fluid-flowing cover may include a plurality of radiating protrusions formed on the lower surface thereof, which radially extend from the center toward the cylindrical body and protrude inward from a lower surface of the fluid-flowing cover so as to define between the radiating protrusions flow grooves, which radially extend from the center and through which the operational fluid flows, wherein top surfaces of the flow grooves are inclined toward the center of the fluid-flowing cover at a predetermined angle when the fluid-flowing cover is coupled to the cylindrical body.

The heat dissipation structure for an LED may further include a thermoelement, which is disposed on the upper portion of the fluid-flowing cover so as to surround the fluid-flowing cover.

The plurality of radiating fins may be circumferentially spaced apart from each other, and may have a smaller length than the cylindrical body in a longitudinal direction, the plurality of radiating fins extending in the same direction as the fluid through space, the partition and the fine capillary pipes, wherein the fine capillary pipes are configured to have a polygonal shape having edges.

In accordance with another aspect of the present invention, there is provided an LED lighting lamp including a heat dissipation structure for an LED, including a cylindrical body, a plurality of radiating fins, a fluid through space, a partition, fine capillary pipes, a fluid-flowing cover and a thermoelement, an LED module disposed on the upper surface of the heat dissipation structure for the LED, a lens disposed on the upper surface of the heat dissipation structure so as to surround the LED module, an upper cover, which is positioned on the radiating fins of the heat dissipation structure and surrounds the upper portion of the fluid through space, a lower fixing bracket, which is positioned under the radiating fins of the heat dissipation structure and surrounds the lower portion of the fluid through space, and a socket disposed under the lower fixing bracket.

The heat dissipation structure for an LED may include the cylindrical body, which includes inner and outer walls each having a hollow cylindrical shape, and which is closed at the upper end thereof by a circular plate, the plurality of radiating fins integrally formed on the outer surface of the cylindrical body, the fluid through space, which is defined between the inner and outer walls of the cylindrical body and which is filled with operational fluid, at least one partition disposed in the fluid through space to divide the fluid through space into a plurality of space segments, the plurality of fine capillary pipes, which are formed on the inner surface of the fluid through space and which constitute flow paths using capillary force, the fluid-flowing cover, which is detachably coupled to the upper portion of the cylindrical body so as to communicate with the fluid through space and uniformly distribute the operational fluid throughout the upper portion of the cylindrical body, and the thermoelement, which is disposed between the LED module and the fluid-flowing cover to surround the fluid-flowing cover, wherein the fluid-flowing cover includes a plurality of radiating protrusions formed on the lower surface of thereof, which radially extend from the center toward the cylindrical body and protrude inward from a lower surface of the fluid-flowing cover, so as to define between the radiating protrusions flow grooves, which radially extend from the center and through which the operational fluid flows, wherein top surfaces of the flow grooves are inclined toward the center of the fluid-flowing cover at a predetermined angle when the fluid-flowing cover is coupled to the cylindrical body, wherein the plurality of radiating fins are circumferentially spaced apart from each other and have a smaller length than the cylindrical body in a longitudinal direction, the plurality of radiating fins extending in the same direction as the fluid through space, the partition and the fine capillary pipes, wherein the fine capillary pipes are configured to have a polygonal shape having edges.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing a heat dissipation structure for an LED according to an embodiment of the present invention;

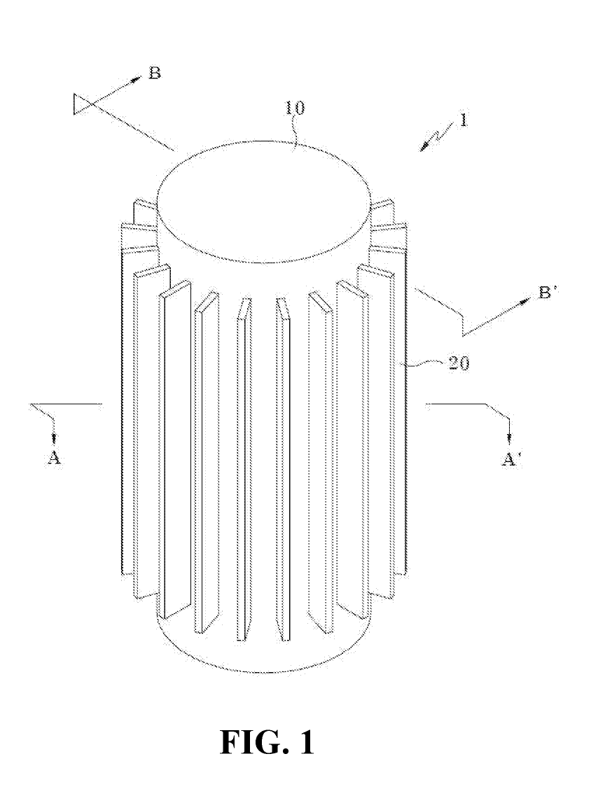

FIG. 2 is a cross-sectional view taken along line A-A′ of FIG. 1;

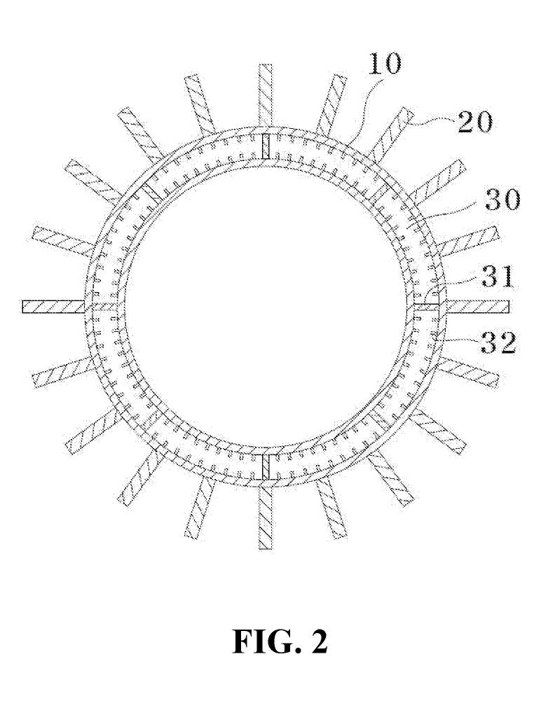

FIG. 3 is a cross-sectional view taken along line B-B′ of FIG. 1;

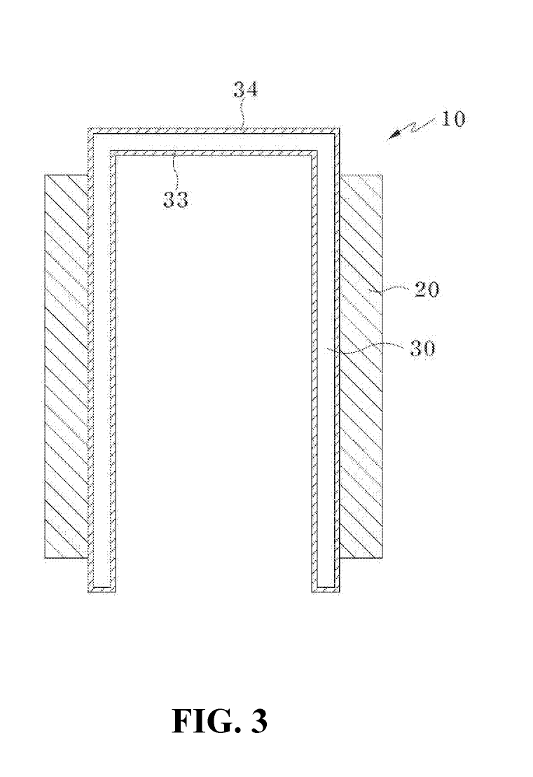

FIG. 4 is a perspective view of a fluid-flowing cover, which is detachably coupled to an upper portion of the heat dissipation structure for an LED according to the present invention;

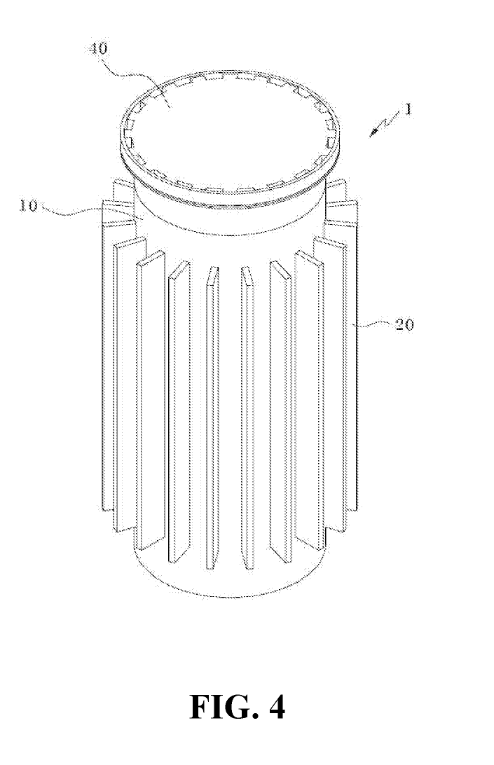

FIG. 5 is a perspective view showing the fluid-flowing cover of FIG. 4, which is inverted;

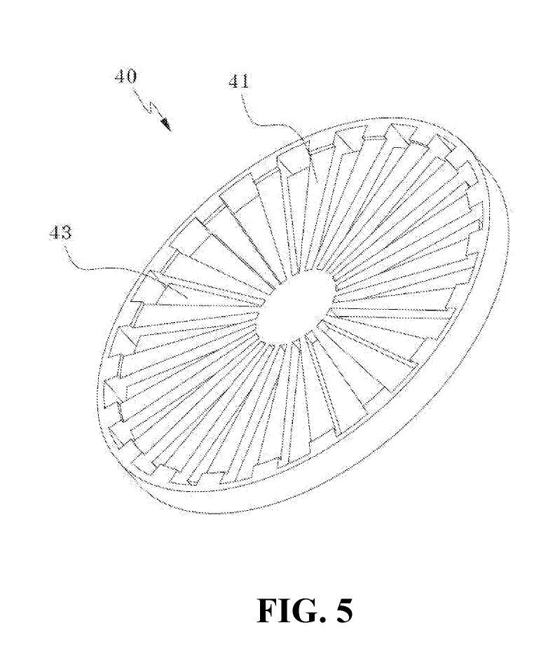

FIG. 6 is a perspective view showing another embodiment of the fluid-flowing cover of FIG. 5;

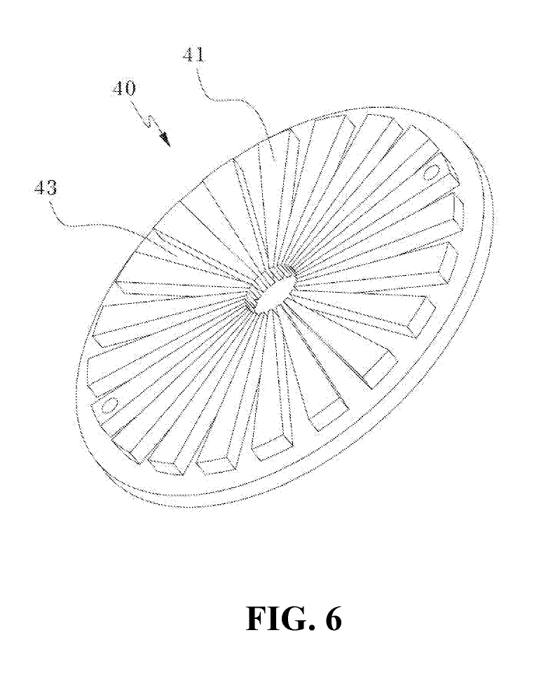

FIG. 7 is a perspective view showing an LED lighting lamp including the heat dissipation structure for an LED according to an embodiment of the present invention;

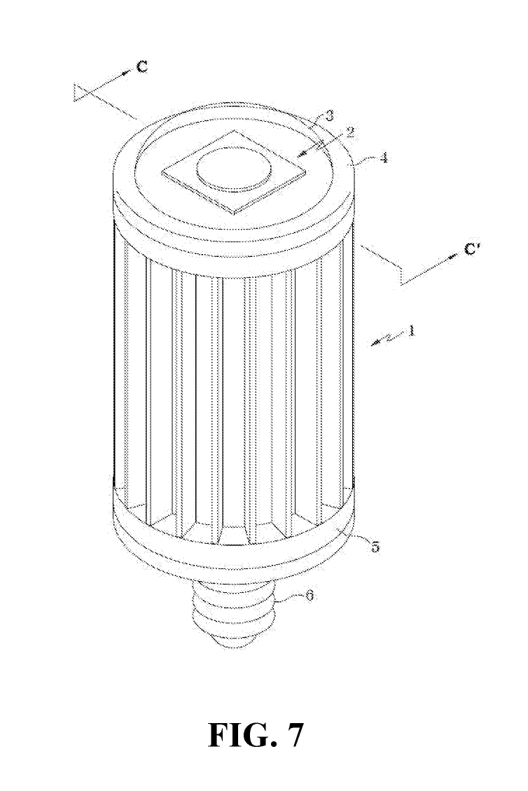

FIG. 8 is a cross-sectional view taken along line C-C′ of FIG. 7;

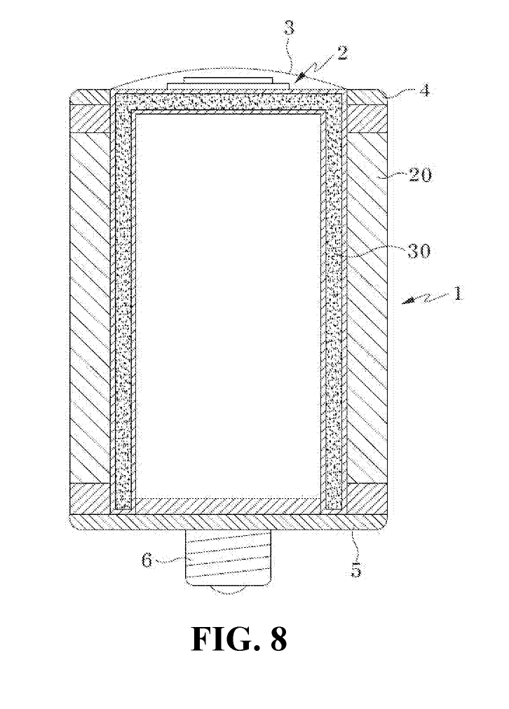

FIG. 9 is an exploded side view showing the LED lighting lamp including the heat dissipation structure for an LED according to the present invention, in which a thermoelement is coupled between the LED module and the fluid-flowing cover;

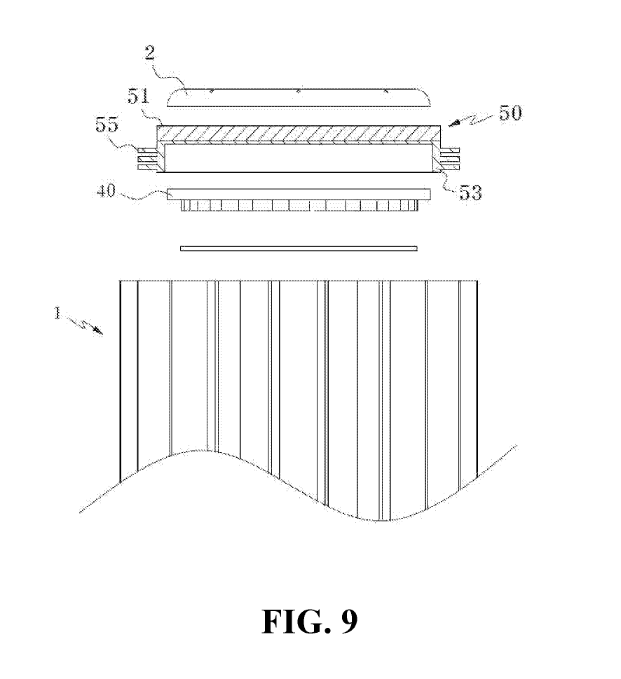

FIG. 10 is a perspective view of the thermoelement of FIG. 9;

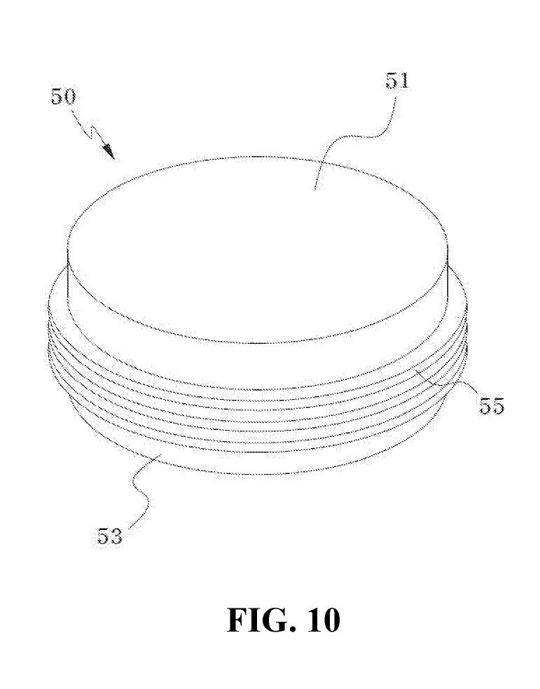

FIG. 11 is a side view showing a fluid-flowing cover according to another embodiment of the present invention;

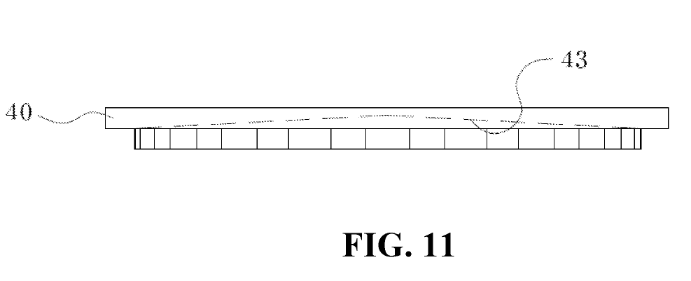

FIG. 12 is a side view showing a fluid-flowing cover according to another embodiment of FIG. 11;

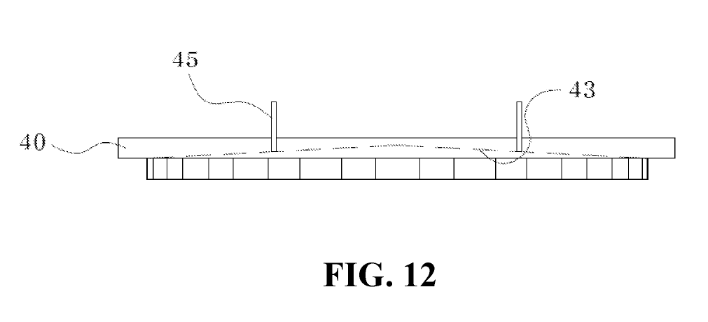

FIG. 13 is a view showing another embodiment of FIG. 2; and

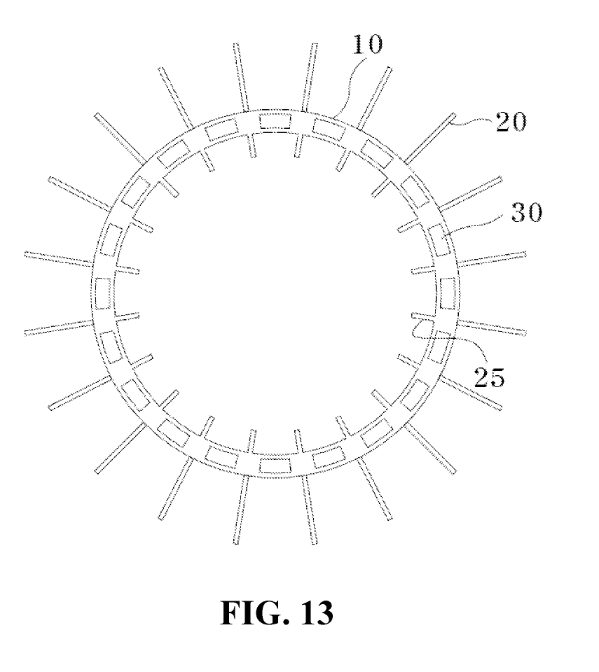

FIG. 14 is a view showing another embodiment of FIG. 13.

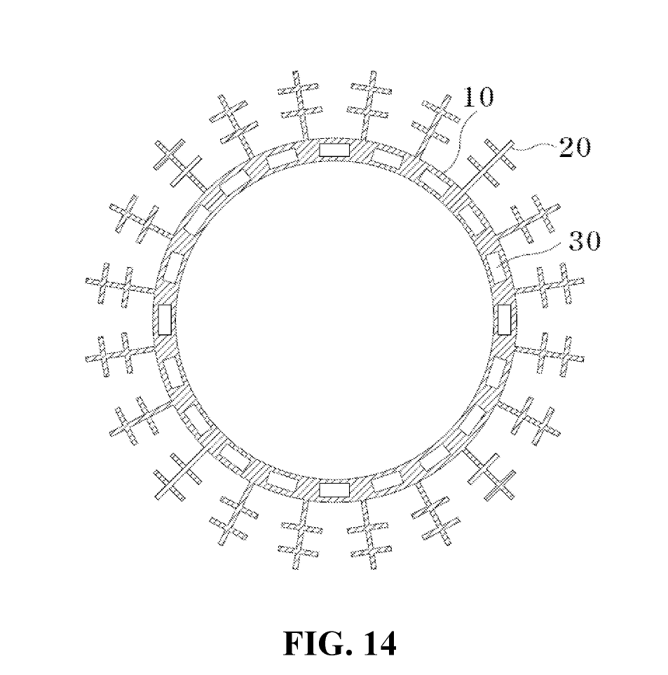

### DETAILED DESCRIPTION OF THE INVENTION

Hereinafter, preferred embodiments of the present invention are described in detail. It should be understood that the embodiments of the present invention disclosed herein are only for illustrative purposes of the present invention, and the present description is not intended to limit the present invention to those embodiments.

The heat dissipation structure 1 for an LED according to the present invention includes a cylindrical body 10, which includes outer and inner hollow cylindrical walls and is closed at the upper face thereof by a circular plate, a plurality of radiating fins 20 integrally formed on the outer surface of the cylindrical body 10, a fluid through space 30, which is defined between the outer and inner walls of the cylindrical body 10 and is filled with operational fluid such that the operational fluid can flow therethrough, one or more partitions 31 disposed in the fluid through space 30 so as to divide the fluid through space 30, a plurality of fine capillary tubes 32 formed on the inner surface of the fluid through space 30 so as to provide flow paths for the operational fluid using the capillary force, and a fluid-flowing cover 40, which is detachably coupled to the upper end of the cylindrical body 10 so as to communicate with the fluid through space 30 and allow the operational fluid to be uniformly distributed throughout the upper portion of the cylindrical body 10.

The heat dissipation structure 1 for a LED serves to rapidly transmit heat generated from the LED to the plurality of radiating fins 20 via the operational fluid in the fluid through space 30, thereby radiating the heat to the outside.

The cylindrical body 10 may be made of metal having excellent heat conductivity, such as aluminum, copper, stainless steel, ceramic and tungsten, and may contain therein the operational fluid, which is injected from the outside, under vacuum pressure for the sake of heat dissipation.

Since the plurality of radiating fins 20 are integrally formed with the cylindrical body 10 through an extrusion process, there are effects of simplifying the manufacturing process and reducing manufacturing costs. In addition, there is an effect of reducing or eliminating heat resistance at the boundary between the plurality of radiating fins 20 and the cylindrical body 10.

The plurality of radiating fins 20 are configured such that they are circumferentially spaced apart from each other at regular intervals and have a smaller length than the cylindrical body 10. The plurality of radiating fins 20 extend in the same longitudinal direction as the fluid through space 30, the partitions 31 and the fine capillary pipes 32.

In another embodiment of the present invention, the radiating fins 20 may extend radially from the outer surface of the cylindrical body 10, and may further extend in a branching form from the outer ends thereof.

The cylindrical body 10 is closed at the lower end thereof such that the fluid through space 30 becomes an enclosed space, thereby preventing the operational fluid contained in the fluid through space 30 from leaking to the outside. The inner wall of the cylindrical body 10 is cut away at the upper end by a length of 2-6 mm, and a first circular plate 33 is bonded to the cut upper end of the inner wall. Subsequently, a second circular plate 34 is bonded to the upper end of the outer wall of the cylindrical body 10. Consequently, the operational fluid flows up to the upper portion of the cylindrical body 10, and comes close to the area on which the LED module 2 is mounted, thereby remarkably improving the heat dissipation efficiency.

In the removal of the upper portion of the inner wall of the cylindrical body 10, if the length of the cut portion exceeds 6 mm, the heat dissipation efficiency is decreased in proportion to the length of the cut portion, and the amount of the operational fluid that is present in the upper portion is increased, thereby making it difficult to rapidly transmit heat to the radiating fins 20 and increasing manufacturing costs. In contrast, if the length of the cut portion is below 2 mm, the amount of operational fluid flowing through the upper portion of the cylindrical body 10 is reduced, thereby decreasing the heat dissipation efficiency.

The operational fluid may be made of a phase-change material serving as a heat transmitting medium, which is composed of at least one of acetone, methanol, water and mercury. Consequently, the heat contained in the operational fluid may be dissipated by the change of phase between the liquid phase and the vapor phase of the operational fluid while the fluid through space 30 is maintained in a vacuum state.

The partitions 31 are disposed in the fluid through space such that the fluid through space 30 is divided into a plurality of flow passages.

The fine capillary pipes 32 are formed on the inner surface of the fluid through space 30, and have edge portions that define a corrugated cross-section. Accordingly, the capillary force is generated and the flow paths for the operational fluid are defined by virtue of the edge portions of the fine capillary pipes 32. The fine capillary pipes 32 may be provided on at least one of the inner surface of the inner wall and the inner surface of the outer wall.

The cylindrical body 10 may be configured to have one of bilaterally symmetrical shapes, including a square column shape and a hexagonal column shape, in addition to the cylindrical column shape. In the case of having a different cross-sectional shape, the cylindrical body 10 is changed only in the cross-sectional shape, and the configurations and functions of the other components are the same as those of the cylindrical body 10.

The fluid-flowing cover 40 is constructed such that a plurality of radiating protrusions 41, which radially extend from the center toward the cylindrical body 10 and protrude inward from the lower surface of the fluid-flowing cover 40, are formed on the lower surface of the fluid-flowing cover 40 so as to define flow grooves 43 between the radiating protrusions 41, which radially extend from the center and through which the operational fluid flows.

As a result, the heat transmitted from the LED module 2 is efficiently transmitted and radiated through the radiating protrusions 41 while the operational fluid evenly flow through the flow grooves 43 over the entire upper portion of the cylindrical body 10, thereby further improving the heat dissipation efficiency of the heat dissipation structure 1 for an LED.

In an embodiment of the present invention, the center portion of the fluid-flowing cover 40 protrudes inward together with the radiating protrusions 41 such that the streams of the operational fluid flowing through the flow grooves 43 are obstructed by the center portion.

In another embodiment of the present invention, the center portion of the fluid-flowing cover 40 may be depressed below the radiating protrusions 41, together with the flow grooves 43 such that the streams of the operational fluid flowing through the flow grooves 43 communicate with each other.

Since the radiating protrusions 41 and the flow grooves 43 of the fluid-flowing cover 40 are configured to be radially arranged, the space in each of the flow grooves 43 is increasingly narrowed toward the center. Alternatively, the top surfaces of the flow grooves 43 of the fluid-flowing cover 40 may be upwardly inclined toward the center at an angle of about 3°, so that the operational fluid flows through the flow grooves at a constant flow rate, thereby offering uniform heat dissipation efficiency throughout the entire upper portion.

From repeated experimentation, it was found that it is most preferable to set the number of radiating protrusions 41 or the flow grooves 43 to be twenty in the interest of maximizing the heat dissipation efficiency of the heat dissipation structure 1 for an LED.

More preferably, the heat dissipation structure 1 for an LED according to the present invention further includes a thermoelement 50, which surrounds the upper surface of the fluid-flowing cover 40.

The thermoelement 50, which is a Peltier element that employs the Peltier effect, includes a heat-absorbing part 51, which constitutes the upper part of the thermoelement 50 and contacts the LED module 2 to absorb heat generated from the LED module 2 to thus cool the LED module 2, and a heat-generating part 53, which constitutes the lower part of the thermoelement 50. The heat-generating part 53 is configured to surround the fluid-flowing cover 40 and is provided on the outer surface thereof with a plurality of heat-transfer extension fins 55, which extend radially outward so as to more efficiently dissipate heat from the heat-generating part 53.

Accordingly, in the LED lighting lamp including the heat dissipation structure 1 for an LED, the thermoelement 50 directly absorbs heat from the LED module 2 to thus cool the LED module 2, thereby further improving the heat dissipation efficiency of the heat dissipation structure 1 for an LED.

Power required to activate the thermoelement 50 may be obtained from the LED module 2.

A heat dissipation structure for an LED according to another embodiment of the present invention includes a square column body, which includes outer and inner hollow square column walls, a plurality of radiating fins integrally formed on the outer surface of the square column body, a fluid through space, which is defined between the outer and inner walls of the square column body and is filled with operational fluid such that the operational fluid can flow therethrough, one or more partitions disposed in the fluid through space so as to divide the fluid through space, and a plurality of fine capillary tubes formed on the inner surface of the fluid through space so as to provide flow paths for the operational fluid using capillary force.

The square column body is closed at the lower end thereof such that the fluid through space becomes an enclosed space, thereby preventing the operational fluid contained in the fluid through space from leaking to the outside. The inner wall of the square column body is cut away at the upper end by a length of 2-6 mm, and a first square plate is bonded to the cut upper end of the inner wall. Subsequently, a second square plate is bonded to the upper end of the outer wall of the square column body. Consequently, the operational fluid flows up to the upper portion of the square column body and comes close to the area on which the LED module 2 is mounted, thereby remarkably improving heat dissipation efficiency.

Hereinafter, an LED lighting lamp including the heat dissipation structure 1 for an LED according to the present invention is described in detail.

The LED lighting lamp including the heat dissipation structure for an LED according to the present invention includes the heat dissipation structure 1 for an LED, which includes the cylindrical body 10, the plurality of radiating fins 20, the fluid through space 30, the partitions 31, the fine capillary pipes 32, the fluid-flowing cover 40 and the thermoelement 50; the LED module 2, which is disposed on the upper surface of the heat dissipation structure 1 for an LED; a lens 3, which is disposed on the upper surface of the heat dissipation structure 1 to surround the LED module 2; an upper cover 4, which is positioned on the radiating fins 20 of the heat dissipation structure 1 and surrounds the upper portion of the fluid through space 30; a lower fixing bracket 5, which is positioned under the radiating fins 20 of the heat dissipation structure 1 and surrounds the lower portion of the fluid through space 30; and a socket 6, which is disposed under the lower fixing bracket 5.

As previously described above, the heat dissipation structure 1 for an LED includes a cylindrical body 10, which includes outer and inner hollow cylindrical walls and is closed at the upper face thereof by a circular plate, a plurality of radiating fins 20, which are integrally formed on the outer surface of the cylindrical body 10, a fluid through space 30, which is defined between the outer and inner walls of the cylindrical body 10 and is filled with operational fluid such that the operational fluid can flow therethrough, one or more partitions 31, which are disposed in the fluid through space 30 so as to divide the fluid through space 30, a plurality of fine capillary tubes 32, which are formed on the inner surface of the fluid through space 30 so as to provide flow paths for the operational fluid using capillary force, a fluid-flowing cover 40, which is detachably coupled to the upper end of the cylindrical body 10 so as to communicate with the fluid through space 30 and allow the operational fluid to be uniformly distributed throughout the upper portion of the cylindrical body 10, and the thermoelement 50, which is disposed between the LED module 2 and the fluid-flowing cover 40 to surround the fluid-flowing cover 40.

The fluid-flowing cover 40 is constructed such that a plurality of radiating protrusions 41, which radially extend from the center toward the cylindrical body 10 and protrude inward from the lower surface of the fluid-flowing cover 40, are formed on the lower surface of the fluid-flowing cover 40 so as to define flow grooves 43 between the radiating protrusions 41, which radially extend from the center and through which the operational fluid flows.

Since the detailed description of the fluid-flowing cover 40 and the thermoelement 50 of the heat dissipation structure 1 for an LED is the same as the above description, it is omitted from the following description.

The plurality of radiating fins 20 are configured such that they are circumferentially spaced apart from each other at regular intervals and are shorter than the cylindrical body 10. The plurality of radiating fins 20 extend in the same longitudinal direction as the fluid through space 30, the partitions 31 and the fine capillary pipes 32. The fine capillary pipes 32 are configured to have a polygonal shape having edges.

The cylindrical body 10 is closed at the lower end thereof such that the fluid through space 30 becomes an enclosed space, thereby preventing the operational fluid contained in the fluid through space 30 from leaking to the outside. The inner wall of the cylindrical body 10 is cut away at the upper end by a length of 2-6 mm, and a first circular plate 33 is bonded to the cut upper end of the inner wall. Subsequently, a second circular plate 34 is bonded to the upper end of the outer wall of the cylindrical body 10. Consequently, the operational fluid flows up to the upper portion of the cylindrical body 10, thereby improving the heat dissipation efficiency.

The LED lighting lamp including the heat dissipation structure for an LED according to the present invention is constructed such that the heat generated by the LED module 2 attached to the upper portion of the cylindrical body 10 is rapidly dissipated to the outside in such a manner that the heat is transmitted to the radiating fins 20 through the operational fluid, which flows to the upper portion through the fluid through space 30 having therein the flow paths, thereby remarkably improving heat dissipation efficiency.

As is apparent from the above description, according to the present invention, since the cylindrical body and the plurality of radiating fins formed on the outer surface of the cylindrical body are integrally formed with each other through an extrusion process, there are effects of simplifying the manufacturing process and reducing manufacturing costs.

In addition, since the cylindrical body and the plurality of radiating fins are integrally formed with each other, there is an effect of reducing or eliminating heat resistance at the boundary between the plurality of radiating fins and the cylindrical body.

Furthermore, since the heat generated by the LED module attached to the upper portion of the cylindrical body is rapidly dissipated to the outside in such a manner that the heat is transmitted to the radiating fins through the operational fluid, which flows to the upper portion through the fluid through space having the flow paths, there is an effect of remarkably improving heat dissipation efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A heat dissipation structure for an LED comprising:
a cylindrical body, which includes inner and outer walls each having a hollow cylindrical shape, and which is closed at an upper end thereof by a circular plate;
radiating fins integrally formed on an outer surface of the cylindrical body;
a fluid through space, which is defined between the inner and outer walls of the cylindrical body and which is filled with operational fluid;
at least one partition disposed in the fluid through space to divide the fluid through space into a plurality of space segments;
a plurality of fine capillary pipes, which are formed on an inner surface of the fluid through space and which constitute flow paths using capillary force; and
a fluid-flowing cover, which is detachably coupled to an upper portion of the cylindrical body so as to communicate with the fluid through space and uniformly distribute the operational fluid throughout the upper portion of the cylindrical body.

2. The heat dissipation structure for an LED according to claim 1, wherein the fluid-flowing cover includes on a lower surface thereof a plurality of radiating protrusions, which radially extend from the center of the fluid flowing cover toward the cylindrical body and protrude inward from a lower surface of the fluid-flowing cover, so as to define between the radiating protrusions flow grooves, which radially extend from the center of the fluid flowing cover and through which the operational fluid flows,
wherein top surfaces of the flow grooves are inclined toward the center of the fluid-flowing cover at a predetermined angle when the fluid-flowing cover is coupled to the cylindrical body.

3. The heat dissipation structure for an LED according to claim 2, further comprising a thermoelement, which is disposed on an upper portion of the fluid-flowing cover so as to surround the fluid-flowing cover.

4. The heat dissipation structure for an LED according to claim 1, wherein the plurality of radiating fins are circumferentially spaced apart from each other and are shorter than the cylindrical body in a longitudinal direction, the plurality of radiating fins extending in the same direction as the fluid through space, the partition and the fine capillary pipes,
wherein the fine capillary pipes are configured to have a polygonal shape having edges.

5. An LED lighting lamp including a heat dissipation structure for an LED, comprising:
the heat dissipation structure for an LED, including a cylindrical body, a plurality of radiating fins, a fluid through space, a partition, fine capillary pipes, a fluid-flowing cover and a thermoelement;
an LED module disposed on an upper surface of the heat dissipation structure for an LED;
a lens disposed on the upper surface of the heat dissipation structure to surround the LED module;
an upper cover, which is positioned on the radiating fins of the heat dissipation structure and surrounds an upper portion of the fluid through space;
a lower fixing bracket, which is positioned under the radiating fins of the heat dissipation structure and surrounds a lower portion of the fluid through space; and
a socket disposed under the lower fixing bracket.

6. The LED lighting lamp according to claim 5, wherein the heat dissipation structure for an LED comprises:
the cylindrical body, which includes inner and outer walls each having a hollow cylindrical shape, and which is closed at an upper end thereof by a circular plate;
the plurality of radiating fins integrally formed on an outer surface of the cylindrical body;
the fluid through space, which is defined between the inner and outer walls of the cylindrical body and which is filled with operational fluid;
at least one partition disposed in the fluid through space to divide the fluid through space into a plurality of space segments;
the plurality of fine capillary pipes, which are formed on an inner surface of the fluid through space and which constitute flow paths using capillary force;
the fluid-flowing cover, which is detachably coupled to an upper portion of the cylindrical body so as to communicate with the fluid through space and uniformly distribute the operational fluid throughout the upper portion of the cylindrical body; and
the thermoelement, which is disposed between the LED module and the fluid-flowing cover to surround the fluid-flowing cover,
wherein the fluid-flowing cover includes a plurality of radiating protrusions formed on a lower surface thereof, which radially extend from the center toward the cylindrical body and protrude inward from a lower surface of the fluid-flowing cover, so as to define, between the radiating protrusions, flow grooves, which radially extend from the center and through which the operational fluid flows,
wherein top surfaces of the flow grooves are inclined toward the center of the fluid-flowing cover at a predetermined angle when the fluid-flowing cover is coupled to the cylindrical body,
wherein the plurality of radiating fins are circumferentially spaced apart from each other and are shorter length than the cylindrical body in a longitudinal direction, the plurality of radiating fins extending in the same direction as the fluid through space, the partition and the fine capillary pipes,
wherein the fine capillary pipes are configured to have a polygonal shape having edges.
